(19) United States
(12) Patent Application Publication
(10) Pub. No.: US 2026/0296317 A1
(43) Pub. Date: Oct. 1, 2026

(54) DUMPER VEHICLE WITH A CAMERA SYSTEM

(71) Applicant: Oshkosh Corporation, Oshkosh, WI (US)

(72) Inventors: Dragos Alexandru Calugaru, Manresa (ES); Marc Plans Lladó, Manresa (ES); Albert Hidalgo Torres, Manresa (ES); Anna Rubiralta Fabregas, Manresa (ES); Manel Tirado Galbany, Manresa (ES); Pol Tous Clua, Manresa (ES)

(73) Assignee: Oshkosh Corporation, Oshkosh, WI (US)

(21) Appl. No.: 19/633,624

(22) Filed: Mar. 30, 2026

Related U.S. Application Data
(60) Provisional application No. 63/781,127, filed on Mar. 31, 2025.

(51) Int. Cl. B60R 1/26; B60P 1/04; B60R 21/13; B62D 33/063; G06V 10/10; G06V 20/58; H04N 7/18; H04N 23/95

(52) U.S. Cl. CPC B60R 1/26; B60P 1/04; B60R 21/131; B62D 33/0633; H04N 7/181; B60R 2300/105; B60R 2300/303; B60R 2300/802; G06V 10/16; G06V 20/58; H04N 23/95

(57) ABSTRACT

A dumper vehicle includes an operator console with a seat and one or more machine controls configured to selectively set a drive condition, a dump box pivotably coupled to the chassis so that a position of the dump box is selectively pivotable between a lowered position and a raised position, a camera system including a plurality of cameras, a user interface with a display, and a controller. The controller is configured to determine operating characteristics including the drive condition and the position of the dump box, instruct, based on the operating characteristics, the user interface to display a first view with image data from at least one of the plurality of cameras, and instruct, based on a change in the operating characteristics, the user interface to switch from the first view to a second view that includes different or additional image data than the first view.

### CROSS-REFERENCE TO RELATED PATENT APPLICATION

This application claims the benefit of and priority to U.S. Provisional Patent Application No. 63/781,127, filed on Mar. 31, 2025, which is incorporated herein by reference in its entirety.

### BACKGROUND

Dumper vehicles typically carry and transport materials through an environment.

### SUMMARY

In some aspects, the present disclosure relates to a dumper vehicle, including: a chassis; an operator console supported on the chassis and including a seat and one or more machine controls configured to selectively set a drive condition in a forward drive condition, a neutral drive condition, or a reverse drive condition; a dump box pivotably coupled to the chassis so that a position of the dump box is selectively pivotable between a lowered position and a raised position; a camera system including a plurality of cameras, each being positioned in a unique location on the dump box or the operator console and configured to capture image data within a respective region; a user interface including a display; and a controller in communication with the one or more machine controls, the camera system, and the user interface, the controller being configured to: receive the image data from the plurality of cameras; determine operating characteristics of the operator console and the dump box, wherein the operating characteristics include the drive condition and the position of the dump box; instruct, based on the operating characteristics, the user interface to display a first view with image data from at least one of the plurality of cameras; and instruct, based on a change in the operating characteristics, the user interface to switch from the first view to a second view that includes different or additional image data than the first view.

In some aspects, the present disclosure relates to a dumper vehicle, including: a chassis; an operator console supported on the chassis and including a seat, wherein the seat is rotatably arranged within the operator console so that a facing direction of the seat is selectively rotatable between a dump box direction and a counterweight direction; a console position sensor configured to measure the facing direction of the seat; a dump box pivotably coupled to the chassis so that a position of the dump box is selectively pivotable between a lowered position and a raised position; a dump box position sensor configured to measure the position of the dump box; a speed sensor configured to measure a speed of the dumper vehicle; a camera system including a plurality of cameras, each being positioned in a unique location on the dump box or the operator console and configured to capture image data within a respective region; a user interface including a display; and a controller in communication with the console position sensor, the speed sensor, the dump box position sensor, the camera system, and the user interface, the controller being configured to: receive the image data from the plurality of cameras; determine operating characteristics including the facing direction, the speed of the dumper vehicle, and the position of the dump box; instruct, based on the operating characteristics, the user interface to display a first view; and instruct, based on a change in the operating characteristics, the user interface to switch from the first view to a second view, wherein the first view is a dual view with image data from a first camera of the plurality of cameras in first section of the display and the second view is a single view with the image data from the first camera shown expanded over the first section and a second section of the display.

In some aspects, the present disclosure relates to a camera system for a dumper vehicle, the camera system including: a console position sensor configured to measure a facing direction of a seat; a dump box position sensor configured to measure a position of a dump box; a speed sensor configured to measure a speed; a plurality of cameras, each being positioned in a unique location and configured to capture image data within a respective region; a user interface including a display; and a controller in communication with the console position sensor, the speed sensor, the plurality of cameras, and the user interface, the controller being configured to: receive the image data from the plurality of cameras; determine operating characteristics including the facing direction, the speed of the dumper vehicle, and the position of the dump box; instruct, based on the operating characteristics, the user interface to display a first view; and instruct, based on a change in the operating characteristics, the user interface to switch from the first view to a second view, wherein the first view is a dual view with image data from a first camera of the plurality of cameras in first section of the display and the second view is a single view with the image data from the first camera shown expanded over the first section and a second section of the display.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE FIGURES

The disclosure will become more fully understood from the following detailed description, taken in conjunction with the accompanying figures, wherein like reference numerals refer to like elements, in which:

FIG. 1 is a front perspective view of a dumper including a camera system, according to an exemplary embodiment;

FIG. 2 is a rear perspective view of the dumper of FIG. 1;

FIG. 3 is a side view of the dumper of FIG. 1 in a configuration where an operator console is oriented in a first direction;

FIG. 4 is a side view of the dumper of FIG. 1 in a configuration where the operator console is oriented in a second direction;

FIG. 5 is a perspective view of a dumper without an enclosed cab including a camera system, according to an exemplary embodiment;

FIG. 6 is an enlarged perspective view of a camera mounted to a dumper;

FIG. 7 is an enlarged perspective view of a camera mounted a dumper;

FIG. 8 is a side view of a camera mounted to a dump box of the dumper of FIG. 1, with the dump box transparent;

FIG. 9 is a schematic illustration of a control system of a dumper, according to an exemplary embodiment;

FIG. 10 is an exemplary view provided by a display of a dumper;

FIG. 11 is a schematic representation of various views presented on a display of a dumper during various operating conditions and orientations, according to an exemplary embodiment; and

FIG. 12 is a flow chart of an image display method for a dumper with a camera system, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

Referring to the figures generally, the various exemplary embodiments disclosed herein relate to systems, apparatuses, and methods for a dumper with camera system. Dumpers are used in various construction environments to load, move, and dump material from a first location to a second location.

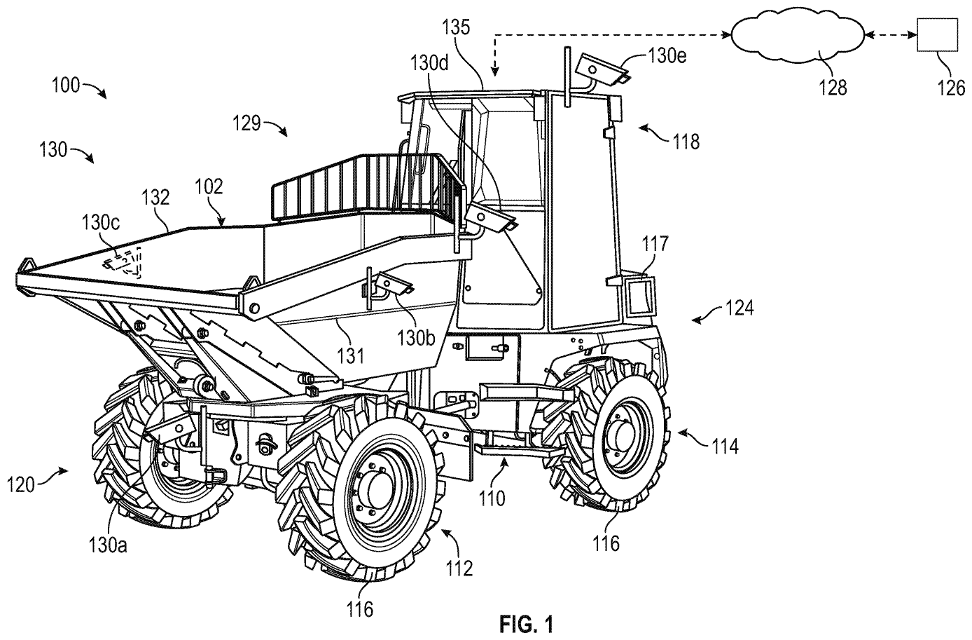

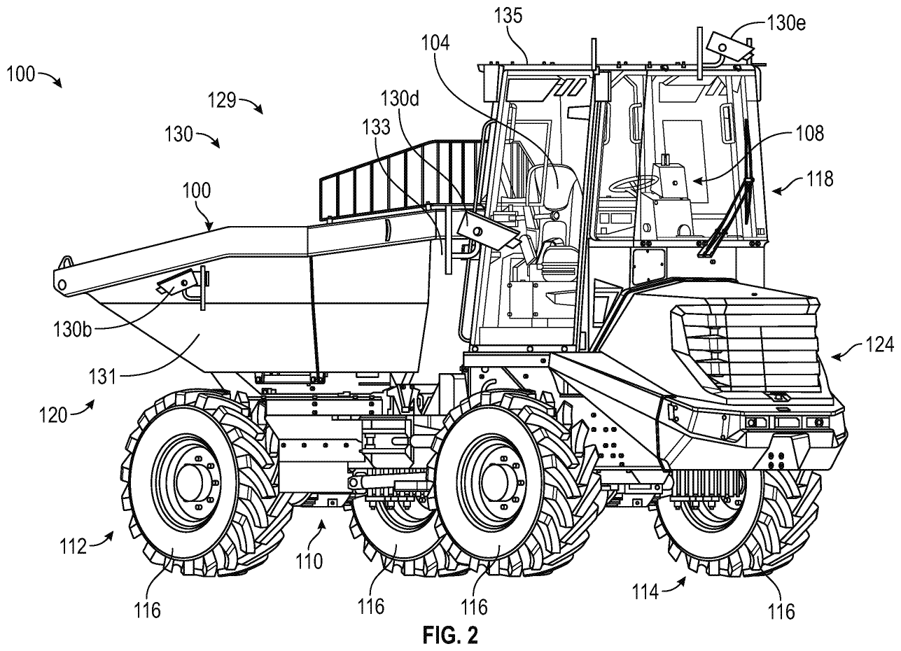

Referring to FIGS. 1 and 2, a work machine, a work vehicle, a dumper vehicle, or a dump truck, shown as dumper 100 is shown according to an exemplary embodiment. In some embodiments, the dumper 100 operates in off-road environments (i.e., the dumper 100 is not intended for on-highway use), for example, construction sites, earth-moving sites, warehouses, municipal jobsites, landscaping projects, demolition projects. In some embodiments, the dumper 100 defines a compact size when compared to conventional on-highway dump trucks.

In the illustrated embodiment, The dumper 100 includes a frame or chassis 110 that supports a dump box 102 and an operator console or cab 118. In general, the dump box 102 defines a storage volume with an open top side so that materials (e.g., construction materials, earth-moving materials, warehouse items, etc.) may be loaded into the storage volume. In some embodiments, the chassis 110 includes a rigid coupling between the dump box 102 and the cab 118. In some embodiments, the chassis 110 includes an articulated coupling between the dump box 102 and the cab 118. In some embodiments, the dump box 102 is pivotable coupled to the chassis 110 so that one end of the dump box 102 may be pivoted relative to the chassis 110 (e.g., via a lift actuator) to facilitate dumping materials out of the dump box 102.

A first axle 112 is coupled to the chassis 110 at a first end 120 of the chassis 110, and a second axle 114 is coupled to the chassis 110 proximate a second end 124 of the chassis 110 (e.g., a counterweight end). In some implementations, the first axle 112 can function as the front axle and the second axle 114 can function as the rear axle. In other implementations, the first axle 112 can function as the rear axle and the second axle 114 can function as the front axle. The first axle 112 and the second axle 114 both include tractive elements (e.g., wheels, treads, etc.), shown as wheel and tire assemblies 116. The first axle 112 and the second axle 114 may include steering components (e.g., steering arms, steering actuators, etc.), suspension components (e.g., gas springs, dampeners, air springs, etc.), braking components (e.g., brake actuators, brake pads, brake discs, brake drums, etc.), and/or other components that facilitate propulsion or support of the dumper 100.

The dumper 100 includes a prime mover, shown as engine 117 that provides rotational energy to propel the wheel and tire assemblies 116. In some embodiments, the engine 117 is coupled to a transmission that defines a drive condition (e.g., forward/neutral/reverse) of the wheel and tire assemblies 116, in response to an input to the one or more machine controls 108 (e.g., a joystick). In some embodiments, engine 117 is disposed in compartment at a second end 124 of the dumper 100. The engine 117 may be configured to utilize one or more of a variety of fuels (e.g., gasoline, diesel, bio-diesel, ethanol, natural gas, etc.), according to various exemplary embodiments. According to an alternative embodiment, the prime mover additionally or alternatively includes one or more electric motors and/or generators (e.g., a hybrid vehicle, an electric vehicle, etc.). The electric motors may consume electrical power from an on-board storage device (e.g., batteries, ultra-capacitors, etc.), from an on-board generator (e.g., an internal combustion engine, a genset, etc.) and provide power to systems of the dumper 100. In some embodiments, the dumper 100 includes an energy storage system and an electric motor. In some embodiments, the prime mover is a hybrid system including an internal combustion engine and one or more electric motors. In some embodiments, dumper 100 does not include an internal combustion engine.

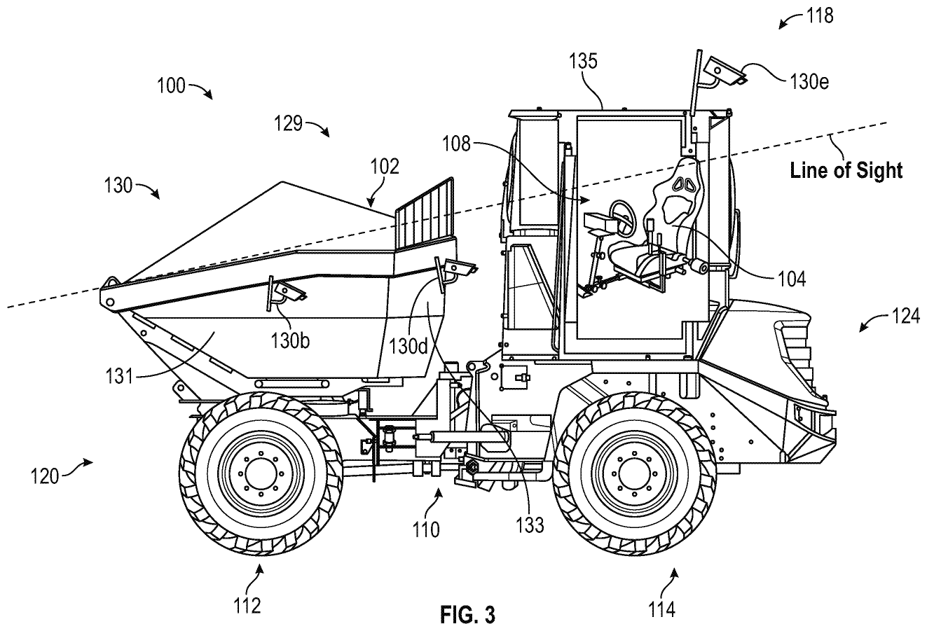

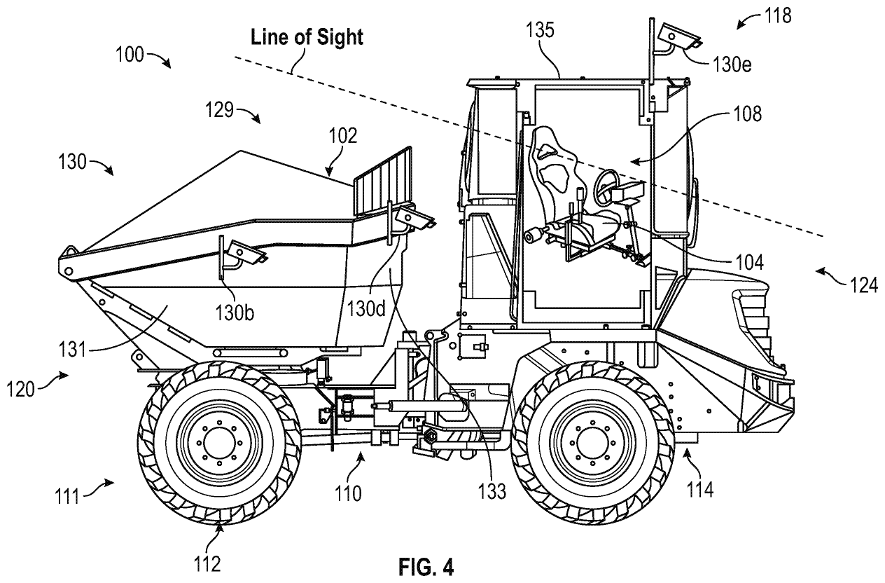

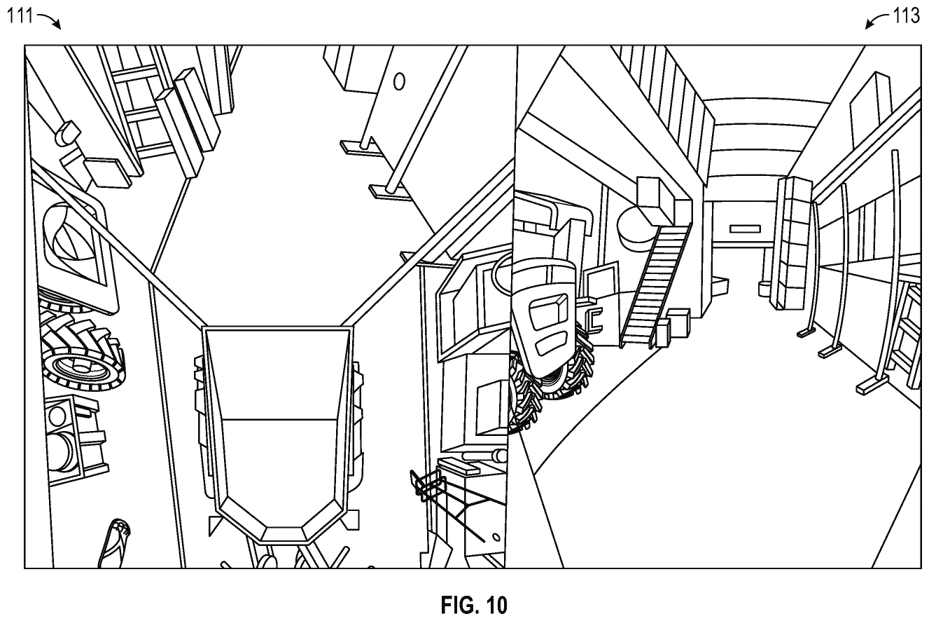

The cab 118 may include various components to facilitate operation of the dumper 100 by an operator. For example, the cab 118 may include a seat 104, pedals 106, one or more machine controls 108 (e.g., steering wheel, joystick(s), lever(s), button(s), knob(s), etc.), and a user interface 111 having a display 113 (see, e.g., FIG. 10). In some embodiments, the operator components (e.g., the seat 104, the pedals 106, the one or more machine controls 108, and the user interface 111) may be rotatable within the cab 118 so that the operator components may face either in a first direction (e.g., toward the dump box 102) or a second direction (e.g., facing away from the dump box 102). FIGS. 3 and 4 illustrate the different operator line of sight orientations for the cab 118. For example, the cab 118 may be in a dump direction where the seat 104, the pedals 106, and the one or more machine controls 108 are oriented so that an operator's line of sight look toward the dump box 102 (see FIG. 3). The operator components within the cab 118 may be rotated from the dump direction to a counterweight direction (see FIG. 4) where the seat 104, the pedals 106, and the one or more machine controls 108 are oriented so that an operator's line of sight look toward the second end 124 (e.g., over a counterweight end of the dumper 100, opposite to the dump box 102).

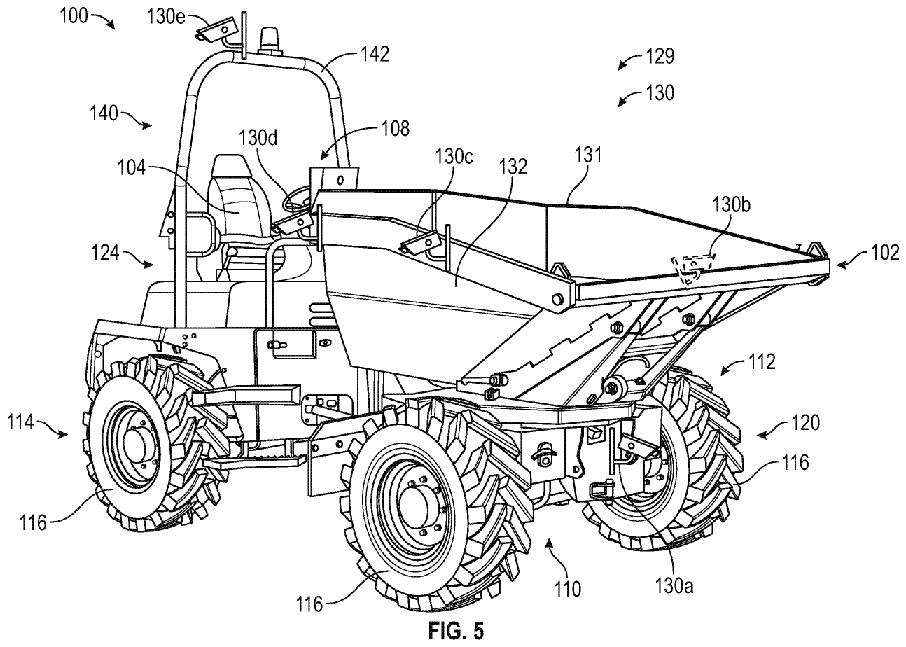

In the illustrated embodiment of FIGS. 1-4, the cab 118 defines a generally enclosed structure where the cab 118 provides a roof over an operator. In the embodiment of FIG. 5, the dumper 100 does not define an enclosed cab and, instead, the seat 104 (and the operator console in general) is open to the environment and a roll-over protection system 140 extends over and around the seat 104. The roll-over protection system 140 includes a roll-over bar 142 that is coupled to the chassis 110 on laterally-opposing sides of the seat 104 and extends over the operator console (e.g., over the seat 104). In the illustrated embodiment, the roll-over bar 142 defines a generally U-shaped profile.

With continued reference to FIG. 1, in some embodiments, the dumper 100 may be communicatively coupled to the user device 126 (e.g., a cellular phone, a tablet, a computer, etc.) through one or more communication protocols or interfaces. According to some embodiments, the communication protocol or interface may be through LAN, USB, Bluetooth (registered trademark), Wi-Fi, 5G, NFC, cellular communication, satellite communication, etc. In some embodiments, the user device 126 may be communicatively coupled to the dumper 100 through a network 128.

In the illustrated embodiment of FIGS. 1-5, the dumper 100 is configured to provide an operator with an enhanced view of the surrounding environment during operation. For example, during forward travel, reverse travel, neutral, turning maneuvers, and/or loading and unloading operations, certain portions of the environment may be obscured by structural components of the dumper 100, such as the dump box 102 or materials in the dump box 102. Accordingly, the dumper 100 may include a camera system 129 that generates and displays a panoramic or 360-degree view by acquiring image data corresponding to regions positioned around the dumper 100, including regions that may not be visible from the seated operator position (e.g., within the cab 118 along the operator's line of sight). Such visibility can facilitate improved maneuverability and operational control, including the ability to detect objects, vehicles, or terrain features that may not be readily visible due to the configuration of the dumper 100. In some embodiments, image data corresponding to blind zones can be used to support functions such as collision avoidance or precise alignment during worksite operations.

The camera system 129 on the dumper 100 includes at least one camera 130 (or other sensor) configured to acquire image data. In some embodiments, the dumper 100 can include a plurality of cameras 130 positioned at different predetermined or unique locations around the dumper 100. For example, the dumper 100 can include five cameras 130, with each of the cameras 130 being oriented to capture image data from a corresponding region around the dumper 100. Each camera 130 can be configured to acquire image data corresponding to one or more surroundings of the dumper 100. For example, one or more of the cameras 130 can be positioned and oriented to capture image data corresponding to objects positioned adjacent to or withing a travel path of the first end 120 or the second end 124 of the dumper 100. In some embodiments, each camera 130 can be mounted at a predetermined position relative to a structural element of the dumper 100 (e.g., the cab 118, the seat 104, the dump box 102, the chassis 110, etc.).

In the illustrated embodiment, the camera system 129 includes five cameras (e.g., a first camera 130a, a second camera 130b, a third camera 130c, a fourth camera 130d, and a fifth camera 130e), each configured to acquire image data from a corresponding region around the dumper 100. The first camera 130a is coupled to the chassis 110 and positioned proximate to the first axle 112. The first camera 130a is oriented to capture image data corresponding to a forward region facing toward the first end 120 (e.g., in a direction away from the seat 104). The second camera 130b is coupled to a first side panel 131 of the dump box 102 and oriented laterally to capture image data corresponding to a first side region. In some embodiments, the second camera 130b is directly coupled to the first side panel 131. The third camera 130c is coupled to a second side panel 132 of the dump box 102 (e.g., laterally-opposite to the first side panel 131) and oriented laterally to capture image data corresponding to a second side region of the dumper 100. The second camera 130b and the third camera 130c are positioned on opposing lateral sides of the dump box 102 to enable bilateral side coverage. In some embodiments, the third camera 130c is directly coupled to the second side panel 132. The fourth camera 130d is coupled to a rear-facing panel 133 of the dump box 102 and is oriented to capture image data in an intermediate region in between the dump box 102 and the seat 104 and facing toward the second end 124 or facing toward the seat 104. The fourth camera 130d is positioned longitudinally between the first axle 112 and the second axle 114 and a vertical positioning of the fourth camera 130d relative to the chassis 110 is selected to provide a view above the second axle 114 and the wheel and tire assemblies 116 coupled thereto.

In some embodiments, the first camera 130a, the second camera 130b, the third camera 130c, and the fourth camera 130d are positioned to capture image data within a field of view on four different sides of the dump box 102. In this way, for example, the first camera 130a, the second camera 130b, the third camera 130c, and the fourth camera 130d capture image data in a 360-degree view around the dump box 102, which is then used to provide video data to an operator during operation, as described herein.

In general, the fifth camera 130e is mounted to the dumper 100 in a location that is separated from the dump box 102 and adjacent to the seat 104 so that the fifth camera 130e captures image data in a rearward region facing toward the second end 124. In some embodiments, the fifth camera 130e is coupled to or mounted on an upper portion or panel 135 of the cab 118 (e.g., a roofline, rooftop bracket, or canopy rail, etc.), as shown in FIGS. 1-4. In some embodiments, the fifth camera 130e is coupled to the roll-over protection system 140, for example, coupled directly to the roll-over bar 142 (see FIG. 5). The fifth camera 130e is configured to provide a high-angle field of view covering a broad area surrounding the second end 124 of the dumper 100. In some embodiments, the fifth camera 130e can include a wide-angle lens or a fisheye lens to support overhead panoramic viewing. In some embodiments, the fifth camera 130e can be a gimballed or motorized unit configured to rotate or tilt to adjust viewing direction dynamically based on operational conditions or control inputs. For example, the field of view of the fifth camera 130e can be selectively directed toward the first end 120, the second end 124, or one or both lateral sides of the dumper 100.

In some embodiments, each cameras 130a-130e include an optical sensor (e.g., a wide-angle lens camera, a stereoscopic camera, an infrared camera, a thermal imaging camera, a depth camera, or a fisheye camera). The cameras 130a-130e can be configured to capture still images, video streams, or depth-mapped image data. In some embodiments, each of the cameras 130a-130e can be of a same type to provide uniform imaging capabilities and simplify data integration across the camera network. In other embodiments, one or more of the cameras 130a-130e can be configured differently depending on the location, orientation, or desired imaging function. For example, a first subset of the cameras 130 can include depth sensors to support obstacle detection, while a second subset can include wide-angle cameras configured for lateral or rearward coverage. In some implementations, the cameras 130a-130e can also include embedded processing components configured to perform local operations such as filtering, compression, format conversion, or encoding of image data prior to transmission to a downstream processing system.

In some embodiments, each of the cameras 130a-130e can be communicatively coupled to the user device 126 via the communication network 128. The communication between the cameras 130 and the user device 126 can occur through one or more communication protocols or interfaces, including but not limited to: local area network (LAN), universal serial bus (USB), Bluetooth® connection, Wi-Fi, cellular communication, satellite communication, near-field communication (NFC), or 5G connectivity. The network 128 can include one or more wireless or wired links configured to transmit image data from the camera system 129 to the user device 126.

As described herein, the user interface 111 includes the display 113 and is configured to manage, control, and present visual information acquired from one or more of the cameras 130a-130e. The user interface 111 can include hardware components such as display controllers, and associated memory and processing circuitry. In some implementations, the user interface 111 can be configured to render one or more image streams, composite panoramic views, or context-specific visual layouts based on operating parameters of the dumper 100. The user interface 111 can operate autonomously or in coordination with the operator through the display 113 of the user interface 111. In some embodiments, the user interface 111 can store configuration profiles, maintain view preferences, and dynamically switch between display modes based on control logic or external inputs. The user interface 111 can be further configured to receive fused panoramic views generated from multiple cameras and display the unified image in a format adapted to the current driving condition, such as an overhead or side-by-side layout.

The display 113 of the user interface 111 may be configured as a display screen, a monitor, or a tablet visible to the operator during operation of the dumper 100. The user interface 111 can be configured to display real-time image data acquired from one or more of the cameras 130a-130e. In some implementations, the user interface 111 can render individual camera feeds or a composite view generated from a plurality of camera inputs. The user interface 111 can include a graphical user interface that allows the operator to select, zoom, or toggle between views associated with different cameras 130, and the display 113 can respond to such inputs or automatically adjust views based on predefined display logic.

In some embodiments, the user device 126 may be arranged within the cab 118 or otherwise within an operator area adjacent to the seat 104 so that an operator may view the user device 126 during operation. In some embodiments, the user device 126, either in addition to or as an alternative of the user interface 111, displays the real-time image data acquired from one or more of the cameras 130a-130e, as described herein. In some embodiments, the user device 126 is disposed outside the cab 118, or otherwise external to an operator area adjacent to the seat 104. For example, the user device 126 can be positioned at a remote monitoring station, on a handheld device, or on a display panel mounted on an exterior portion of the dumper 100. In certain implementations, the user device 126 can be accessible to a supervisor, technician, or another operator positioned external to the dumper 100, and can be configured to receive and display image data from one or more of the cameras 130a-130e through the network 128.

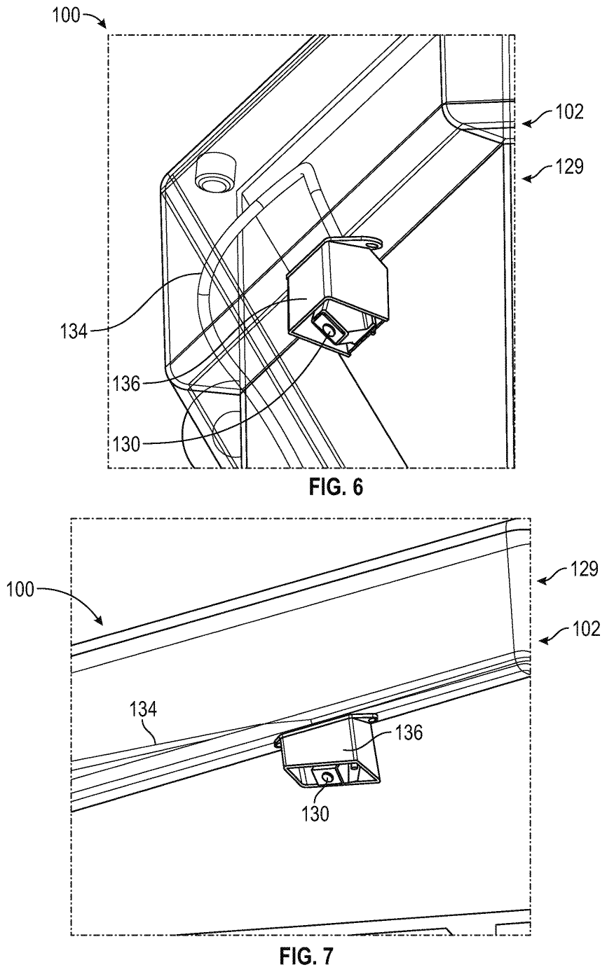

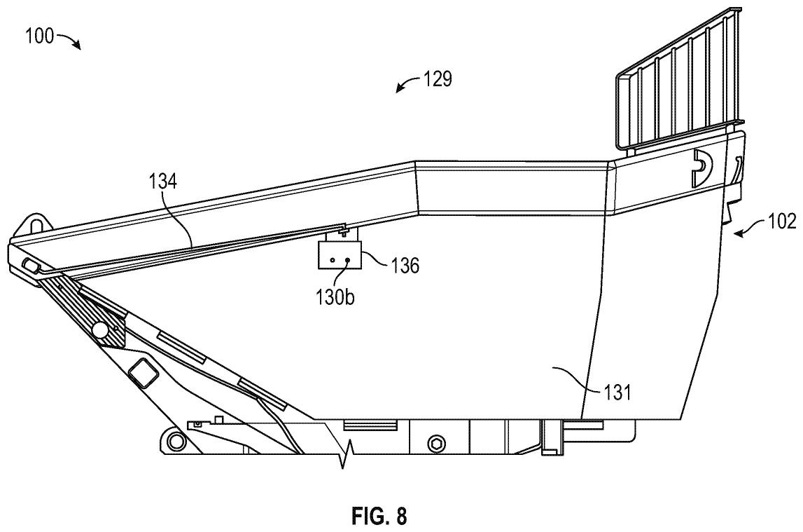

As shown in FIG. 6-8, a representative example of a camera 130 (e.g., any of the cameras 130a, 130b, 130c, 130d, 130e) is illustrated in a mounted configuration on a structural portion of the dumper 100 (e.g., mounting surface on dump box 102, cab 118, the roll-over protection system 140, etc.). A cable 134 (e.g., one or more wires) can extend from the camera 130 to a power source and/or data interface (e.g., a controller), enabling electrical connectivity for image capture and transmission functions. The camera 130 is enclosed within a protective casing 136 that can house one or more optical and electrical components of the camera 130. The casing 136 can be mechanically fastened to the structure using fasteners, brackets, clamps, welding, or integrated mounts. In some embodiments, the casing 136 can be molded, cast, or machined and can be configured to match the shape and orientation of the surface to which it is mounted.

In some embodiments, the casing 136 can be configured to provide environmental protection for the internal components of the camera 130. For example, the casing 136 can be sealed to prevent ingress of dust, moisture, or debris and can include coatings or finishes to resist corrosion or UV degradation. In certain implementations, the casing 136 can be thermally conductive to facilitate heat dissipation or include insulation features to maintain optical performance under temperature fluctuations. The camera 130 can be mounted in a fixed orientation, or in other embodiments, can include a mechanical adjustment feature(s) (e.g., a pivoting bracket, sliding rail, a motor, etc.) to vary the angle or field of view of the camera 130. The cable 134 can be routed through an internal conduit, secured using clips or grommets, or integrated into a cable management system to prevent interference with moving components of the dumper 100. For example, the cable 134 may be routed through internal channels within the dump box 102 for the cameras 130 mounted to the dump box 102 (e.g., the first camera 130a, the second camera 130b, the third camera 130c, and the fourth camera 130d), as shown in FIGS. 6-8.

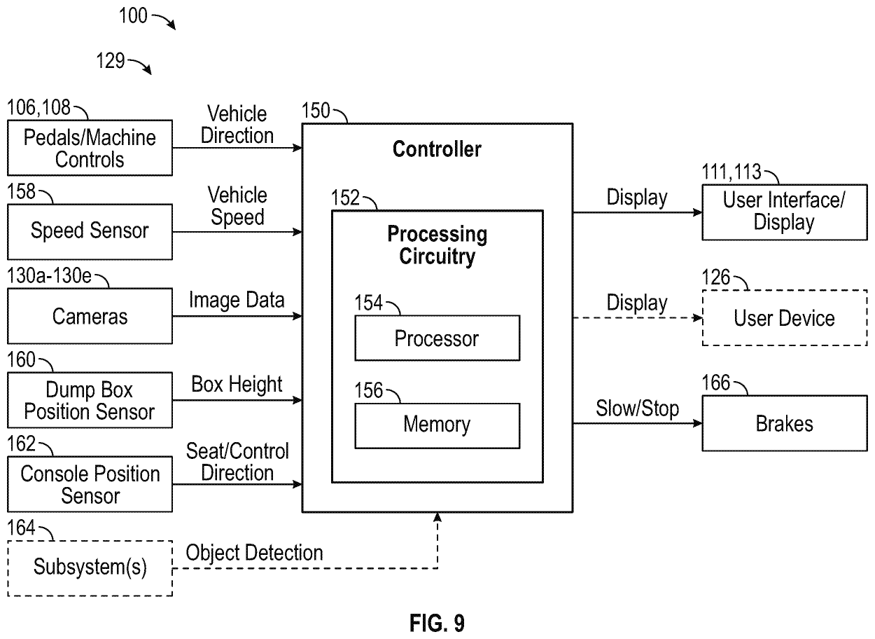

With reference to FIG. 9, the dumper 100 can include a controller 150 configured to coordinate operation of the cameras 130a-130e, the display system, and other subsystems of the dumper 100. In some embodiments, the controller 150 is a native controller on the dumper 100. In some embodiments, the controller 150 is a dedicated controller that is included on the dumper 100 to control operations of the camera system 129 and other subsystems. The controller 150 includes a processing circuit 152 having a processor 154 and memory 156. The processing circuit 152 can be communicably connected to a communications interface such that the processing circuit 152 and the various components thereof can send and receive data via the communications interface. The processor 154 can be implemented as a general purpose processor, an application specific integrated circuit (“ASIC”), one or more field programmable gate arrays (“FPGAs”), a group of processing components, or other suitable electronic processing components.

The memory 156 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 156 can be or include volatile memory or non-volatile memory. The memory 156 can include database components, object code components, script components, or any other type of information structure for supporting the various activities and information structures described in the present application. According to some embodiments, the memory 156 is communicably connected to the processor 154 via the processing circuit 152 and includes computer code for executing (e.g., by the processing circuit 152 and/or the processor 154) one or more processes described herein. The controller can include a processing circuit comprising one or more processors and memory devices. The controller can be implemented as an electronic control unit (ECU) that is integrated with or separate from other functional modules of the dumper 100, such as a motor control unit or drive control unit.

In general, the controller 150 is configured to receive inputs from one or more sensors, including cameras 130a-130e, wheel speed sensors, dump box position sensors, the pedals 106, the one or more machine controls 108, location sensors (e.g., GPS or inertial measurement units), and various other sensors. Based on these inputs, the controller 150 generates output commands to of the user interface 111 and/or the user device 126, such as instructions to update a display, switch camera views, or present fused panoramic imagery. In some embodiments, the controller 150 can be configured to execute control software stored in memory 156, including logic for camera switching, image fusion, 2D overlay rendering, object detection, object classification, and/or alert generation. The memory 156 of the controller 150 can store executable instructions, sensor calibration data, configuration parameters, and user interface settings. The memory 156 can include volatile and non-volatile components, and can support real-time access for tasks such as synchronizing video streams, managing display transitions based on vehicle orientation, or logging detected objects. In some embodiments, the controller 150 may support over-the-air updates, diagnostics, or configuration changes via a communications interface.

In the illustrated embodiment, the dumper 100 includes a speed sensor 158, a dump box position sensor 160, a console position sensor 162, and one or more subsystems 164 in communication with the controller 150. In some embodiments, the speed sensor 158 is in the form of an encoder, a hall-effect sensor, an inductive sensor, an optical sensor, a shaft-speed sensor coupled to a transmission of the dumper 100, or an equivalent sensor that measures a speed of the dumper 100 as it travels in an environment. In general, the dump box position sensor 160 is configured to measure a position of the dump box 102 relative to the chassis 110 as the dump box 102 moves between a stowed or lowered position and a dump or raised position. In some embodiments, the dump box position sensor 160 is in the form of a hall-effect sensor, an actuator position sensor, an angle sensor that measures an angle of the dump box 102 relative to the chassis 110, or an equivalent sensor that measures a position (e.g., height) of the dump box 102 relative to the chassis 110.

The console position sensor 162 is configured to measure a position of the operator console components (e.g., the seat 104, the pedals 106, the one or more machine controls 108, and/or the user interface 111) and provide an input to the controller 150 to indicate if the operator components are facing the dump direction (e.g., toward the first end 120, see FIG. 3) or the counterweight direction (e.g., toward the second end 124, see FIG. 4). In some embodiments, the console position sensor 162 is in the form of an encoder coupled to the seat 104 and/or the one or more machine controls 108, a limit switch coupled to a seat 104 and/or the one or more machine controls 108, an image sensor (e.g., a dedicated camera, or one of the cameras 130, with a field of view that captures the operator) that is configured to detect a line of sight of the operator, a button or switch that is activated by the operator to indicate the direction of the operator components, or an equivalent sensor that is configured to measure a facing direction of the seat 104 and/or the one or more machine controls 108 between the dump direction and the counterweight direction to determine a facing direction of the operator during operation of the dumper 100.

In some embodiments, the dumper 100 includes one or more subsystems 164 that provide additional inputs to the controller 150 that are used in combination with the camera system 129 to control operating parameters (e.g., vehicle speed) of the dumper 100. In some embodiments, the one or more subsystems 164 includes one or more of a radar sensor, a LIDAR sensor, and/or an inertial measurement unit (IMU). In some embodiments, the user interface 111 and/or the user device 126, the controller 150, the dump box position sensor 160, the console position sensor 162, and the one or more subsystems 164 are included within the camera system 129 and facilitate the operations of the camera system 129 (e.g., displaying selective views on the display 113 and/or the user device 126) based on operating characteristics of the dumper 100 as described herein.

In general, the controller 150 is configured to control the user interface 111 and/or the user device 126 based on the inputs provided from the pedals 106/the one or more machine controls 108, the speed sensor 158, the dump box position sensor 160, the console position sensor 162, and/or the one or more subsystems 164. Specifically, the controller 150 is configured to adaptively control image data presentation based on one or more operating states. For example, the controller 150 may be configured to automatically switch between different camera views or composite image arrangements displayed on the display 113 of the user interface 111 and/or a display of the user device 126 based on the inputs provided to the controller 150 (e.g., operating characteristics of the dumper 100). The use of the term “image data” herein is not limited to still images shown in a display (e.g., pictures) and includes the use of video data shown on a display.

In some embodiments, the controller 150 may determine a seat orientation/facing direction of the operator console (e.g., facing the dump direction or facing the counterweight direction) based on the console position sensor 162. Once the facing orientation is determined, the controller 150 may then control the image data that is displayed on the display 113 and/or the user device 126 based on the inputs from the one or more machine controls 108, the speed sensor 158, and the dump box position sensor 160. For example, the controller 150 may display the image data from one of the cameras 130 on the display, or display image data from one of the cameras 130 in combination with image data from a plurality of the cameras 130 in a dual view mode (see, e.g., FIG. 10), depending on the inputs provided by the one or more machine controls 108, the speed sensor 158, and the dump box position sensor 160. In some embodiments, the inputs that determine what image data is displayed on the display 113, in addition to the seat orientation, includes a travel gear (e.g., forward, neutral, reverse, as set by the one or more machine controls 108 (a joystick, a lever, a knob, a button, etc.)), a position of the dump box 102 between the lowered position and the raised position, and a speed of the dumper 100 being greater than or equal to a speed threshold. When the controller 150 displays the image data from a single camera on the display 113 and/or the user device 126, the image data is shown in a single-view layout with a larger viewing area than a dual-view layout or split-screen layout where two different views are shown, each in their own section on the display 113 and/or the user device 126 (see, e.g., FIG. 10). For example, the single view may include image data from one of the plurality of cameras 130 (e.g., the first camera 130a) expanded over a first section and a second section of the display 113 and/or the user device 126, and the dual view may include image data from one of the plurality of cameras and a fused view from a subset of the plurality of cameras 130 (e.g., the first camera 130a, the second camera 130b, the third camera 130c, and the fourth camera 130d).

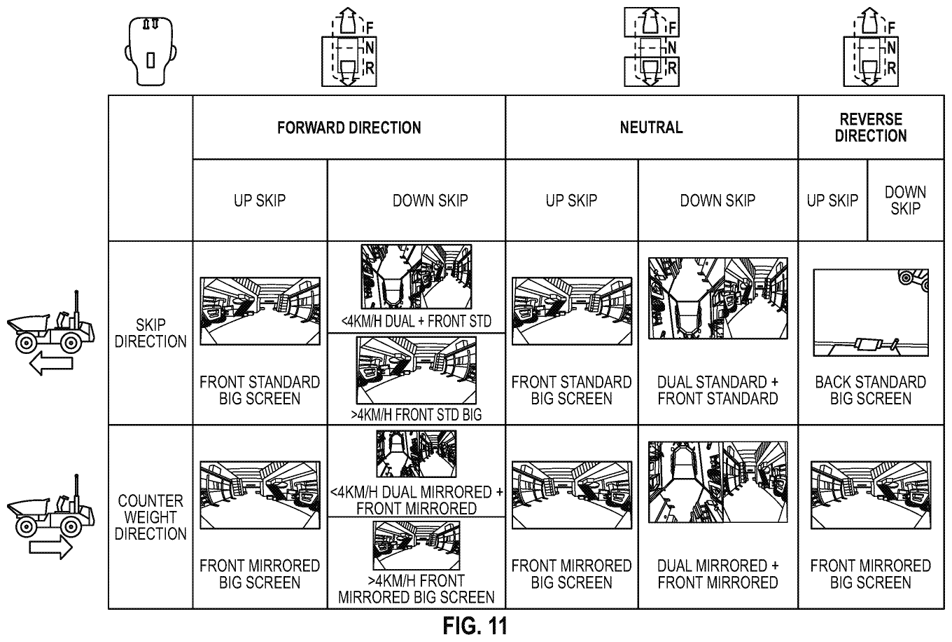

FIG. 11 illustrates the operation of the controller 150 and the image data shown on the display 113 and/or the user device 126 during operation of the dumper 100. In general, the image data from the cameras 130a-130e is selectively displayed on the display 113 and/or the user device 126 (i.e., the display 113 and/or the user device 126 selectively displays video feeds) based on the operator orientation and the operating conditions of the dumper 100 (e.g., forward/neutral/reverse, position of the dump box 102, and/or the speed of the dumper 100). For example, if the console position sensor 162 indicates that the seat 104 and/or the one or more machine controls 108 are facing the dump box direction (i.e., toward the first end 120), the controller 150 may then determine the travel direction, the position of the dump box 102, and the speed of the dumper 100 to determine which of the cameras 130 to use image data from to provide on the display 113 and/or the user device 126. If the one or more machine controls 108 indicate that the dumper 100 is in a forward travel condition (e.g., toward the first end 120), the dump box 102 is in the lowered position, and the speed of the dumper 100 is below a speed threshold, the controller 150 provides the dual-view layout (e.g., two different views, each in their own section on the display) on the display 113 and/or the user device 126 with the image data from the first camera 130a in a first section and a fused view from the each of the first camera 130a, the second camera 130b, the third camera 130c, and the fourth camera 130d (e.g., a subset of the plurality of cameras 130) in a second section. In general, the fused view may be a top plan view with the image data around the dump box 102 from each of the first camera 130a, the second camera 130b, the third camera 130c, and the fourth camera 130d displayed in a section on the display 113 and/or the user device 126. If the operating conditions change so that the one or more machine controls 108 indicate that the dumper 100 is in a forward travel condition, the dump box 102 is in the lowered position, and the speed of the dumper 100 is now above the speed threshold, the controller 150 provides the single-view layout on the display 113 and/or the user device 126 where the image data from the first camera 130a is displayed in both sections on the display. In this way, for example, once the dumper 100 goes faster than the speed threshold, the controller 150 switches from the dual view to a single view where the first camera 130a is prioritized (i.e., the image data from the camera in the direction of travel is prioritized above the speed threshold) and shown on a larger area of the display. In other words, the camera system 129 prioritizes the image data from the first camera 130a, which is already present in the dual view (when the speed is below the speed threshold), during more difficult operating conditions (e.g., going above the speed threshold) by removing the fused view and displaying the image data from the first camera 130a over the larger viewing area. In these operating conditions (e.g., operator console facing toward the dump box 102, the dump box 102 is in the lowered position, and the dumper 100 is in the forward travel condition), crossing the speed threshold is configured to change the image data on the display 113 and/or the user device 126 (e.g., between a single view and a dual view).

In some embodiments, if the dump box 102 is in the raised position and the line of sight of the operator is blocked by the dump box 102, the controller 150 may not toggle between the dual view and the single view based on the speed of the dumper 100. For example, if the console position sensor 162 indicates that the seat 104 and/or the one or more machine controls 108 are facing the dump box direction (i.e., toward the first end 120), the one or more machine controls 108 indicate that the dumper 100 is in a forward travel condition, and the dump box 102 is in the raised position, the controller 150 displays image data from the first camera 130a in the single view on the display 113 and/or the user device 126, regardless of the speed of the dumper 100, which again prioritizes difficult operating conditions (e.g., the dump box 102 is in the raised position).

When the console position sensor 162 indicates that the seat 104 and/or the one or more machine controls 108 are facing the dump box direction (i.e., toward the first end 120) and the one or more machine controls 108 indicate that the dumper 100 is in a neutral travel condition, the controller 150 may change the image data displayed on the display 113 and/or the user device 126 based on the position of the dump box 102. For example, if the dump box 102 is in the raised position, the controller 150 may provide the image data from the first camera 130a in the single view on the display 113 and/or the user device 126. Alternatively, if the dump box 102 is in the lowered position, the controller 150 may provide the dual-view layout on the display 113 and/or the user device 126 with the image data from the first camera 130a and the fused view (e.g., top plan view) from the each of the first camera 130a, the second camera 130b, the third camera 130c, and the fourth camera 130d. In this way, for example, the camera system 129 prioritizes the image data from the first camera 130a, which is already present in the dual view (when the dump box 102 is in the lowered position), during more difficult operating conditions (e.g., the dump box 102 being in the raised position) by removing the fused view and displaying the image data from the first camera 130a over the larger viewing area.

When the console position sensor 162 indicates that the seat 104 and/or the one or more machine controls 108 are facing the dump box direction (i.e., toward the first end 120) and the one or more machine controls 108 indicate that the dumper 100 is in a reverse travel condition (e.g., toward the second end 124), the controller 150 may provide the image data from the fifth camera 130e in the single view on the display 113 and/or the user device 126. In this operating condition, the controller 150 may keep the image data displayed to the display 113 and/or the user device 126 constant (i.e., not change cameras or views), regardless of the speed of the dumper 100 or the position of the dump box 102.

Similar to the adjustment to which of the cameras 130a-130e and the single view or dual view shown on the display 113 and/or the user device 126 in the various operating conditions of the dumper 100 with the seat 104 or the one or more machine controls 108 facing the dump box direction, when the seat 104 is rotated and faces the counterweight direction (e.g., toward the second end 124), the camera system 129 and the controller 150 are configured adjust the image data displayed on the display 113 and/or the user device 126. With continued reference to FIG. 11, if the console position sensor 162 indicates that the seat 104 and/or the one or more machine controls 108 are facing the counterweight direction (i.e., toward the second end 124), the controller 150 may then determine the travel direction, the position of the dump box 102, and the speed of the dumper 100 to determine which of the cameras 130 to use image data from to provide on the display 113 and/or the user device 126. If the one or more machine controls 108 indicate that the dumper 100 is in a forward travel condition (e.g., toward the second end 124), the dump box 102 is in the lowered position, and the speed of the dumper 100 is below a speed threshold, the controller 150 provides the dual-view layout on the display 113 and/or the user device 126 with the image data from the first camera 130a and a fused view from the each of the first camera 130a, the second camera 130b, the third camera 130c, and the fourth camera 130d. The image data from the first camera 130a and the fused view displayed on the display 113 and/or the user device 126 are similar to when the seat 104 and/or the one or more machine controls 108 are facing the dump box direction, but mirrored (e.g., flipped) 180° due to the operator facing an opposing direction (i.e., in the counterweight direction). Additionally, with the operator console facing in the counterweight direction, the dump box 102 is not in the operator's line of sight, so the view from the first camera 130a is still displayed on the display 113 and/or the user device 126 so that the operator can see behind the dump box 102 while traveling in a forward direction (i.e., toward the second end 124).

In the operating conditions above, if the speed of the dumper 100 is above the speed threshold, the controller 150 provides a single view on the display 113 and/or the user device 126 with the image data from the first camera 130a, again mirrored relative to when the seat 104 and/or the one or more machine controls 108 are facing the dump box direction. In this way, for example, once the dumper 100 goes faster than the speed threshold, the controller 150 switches from the dual view to a single view, where the first camera 130a is prioritized during more difficult operating conditions (e.g., moving above the speed threshold). If the seat 104 or the one or more machine controls 108 are still facing in the counterweight direction and the dumper 100 is in the forward travel condition, but the dump box 102 is in the raised position, the controller 150 displays image data from the first camera 130a on the display 113 and/or the user device 126, regardless of the speed of the dumper 100. As such, once the dump box 102 is in the raised position, the controller 150 does not toggle between the dual view and the single view based on the speed of the dumper 100, again prioritizing difficult operating conditions (e.g., moving with the dump box 102 in the raised position).

When the console position sensor 162 indicates that the seat 104 and/or the one or more machine controls 108 are facing the counterweight direction (i.e., toward the second end 124) and the one or more machine controls 108 indicate that the dumper 100 is in a neutral travel condition, the controller 150 may change the image data displayed on the display 113 and/or the user device 126 based on the position of the dump box 102. For example, if the dump box 102 is in the raised position, the controller 150 may provide the image data from the first camera 130a in the single view on the display 113 and/or the user device 126 in the mirrored orientation. Alternatively, if the dump box 102 is in the lowered position, the controller 150 may provide the dual view layout on the display 113 and/or the user device 126 with the image data from the first camera 130a, in the mirrored orientation, and the fused view (e.g., top plan view) from the each of the first camera 130a, the second camera 130b, the third camera 130c, and the fourth camera 130d, in the mirrored orientation.

When the console position sensor 162 indicates that the seat 104 and/or the one or more machine controls 108 are facing the counterweight direction (i.e., toward the second end 124) and the one or more machine controls 108 indicate that the dumper 100 is in a reverse travel condition (e.g., toward the first end 120), the controller 150 may provide the image data from the first camera 130a in the single view on the display 113 and/or the user device 126, in the mirrored orientation. In this operating condition, the controller 150 may keep the image data displayed to the display 113 and/or the user device 126 constant (i.e., not change cameras or views), regardless of the speed of the dumper 100 or the position of the dump box 102.

As described herein, the camera system 129 is configured to vary the image data displayed on the based on a direction of the seat 104, the position of the dump box 102, the speed of the dumper 100, and/or a travel direction of the dumper 100. Additionally, the camera system 129 and the controller 150 are configured to flip or mirror the image data from the cameras 130 displayed on the display to accommodate the direction that the seat 104 and/or the one or more machine controls 108 are facing. Further, the camera system 129 is configured to accommodate certain difficult operating conditions and utilize the single-view layout so that a larger display area is used for the image data that is prioritized during the difficult operating conditions. As described herein, the difficult operating conditions may include the speed of the dumper 100 being above the speed threshold, the dump box 102 being in the raised position, and/or the drive conditions being the reverse drive condition. These properties of the camera system 129 provide an operator with image data on the display 113 and/or the user device 126 that automatically correlates to the operation of the dumper 100, without requiring the operator to manually choose which camera is shown, and aids the operator when maneuvering the dumper 100 in an environment.

In some embodiments, image data from the cameras 130a-130e may be processed by one or more image fusion algorithms stored within the memory 156 of the controller 150 to generate a panoramic or 360-degree view (e.g., the fused view) on the display 113 and/or the user device 126. The image fusion can include pixel-level blending, geometric stitching, perspective correction, and frame synchronization. In some embodiments, the controller 150 is configured to apply machine learning models, such as convolutional neural networks (CNNs), to perform image recognition, region segmentation, and spatial mapping to combine the multiple camera views into a unified visual representation (e.g., the fused view). In some embodiments, the fusion process can be performed using rule-based or threshold-based logic without machine learning.

The image fusion process can be configured to operate in real time and can combine multiple camera feeds to generate a continuous, stitched visual representation of the environment surrounding the dumper 100, and specifically surrounding the dump box 102 in the fused view from the first camera 130a, the second camera 130b, the third camera 130c, and the fourth camera 130d, which are all coupled to different sides of the dump box 102. In some embodiments, the image fusion process can eliminate overlap between adjacent camera views and correct for perspective distortions or parallax mismatches to provide a seamless panoramic image to the operator. In some implementations, the image fusion process can be executed locally within controller 150 and can be configured to continuously update the composite image in real time based on changes in vehicle position, camera input, or detected occlusions.

In some embodiments, the camera system 129 can be configured to render a dynamic two-dimensional (2D) model that is overlaid on the real-time image feed presented to the operator on the display 113 and/or the user device 126. The 2D model can include graphical elements such as boundary lines, terrain contours, proximity markers, directional arrows, and representations of detected objects (e.g., vehicles, barriers, or personnel). The overlay can be continuously updated in response to image data acquired by the cameras 130a-130e, a subset of the cameras 130a-130e (e.g., the cameras 130a-130d), and/or additional sensors, allowing the displayed model to adapt in real time to changes in surroundings or dumper 100 movement. The dynamic 2D model can be superimposed on the composite or individual camera views displayed on the display 113 and/or the user device 126, and can be aligned based on known spatial reference points or positional data (e.g., GPS or IMU data) to maintain consistent scaling and perspective. In some implementations, the 2D overlay can be used to highlight operational zones, delineate no-go regions, or indicate suggested paths or alignment targets during maneuvering, dumping, or reverse driving operations.

In some embodiments, the dumper 100 can be configured to detect objects or persons positioned within one or more regions around the dumper 100 based on the image data acquired by the cameras 130a-130e. For example, one or more image frames can be processed using object recognition logic stored in the memory 156 of the controller 150 to identify the presence of a physical obstacle, vehicle, terrain feature, or human figure. In response to detecting such an object, the controller 150 may be configured to transmit a notification to the display 113 and/or the user device 126. The notification can include a visual indicator overlaid on a rendered view, an audio alert generated through a speaker, or a haptic signal delivered via the display 113, the user device 126, or another one of the machine controls 108. In some embodiments, the controller 150 may be configured to generate an audible alert, via the user interface 111, such as a beeping tone, in response to detecting the presence of a person or object within a predetermined proximity threshold. In some embodiments, the controller 150 may be configured to transmit a control signal to one or more subsystems to initiate a predefined operational response, based on the detection of an object within a predefined threshold. For example, if an object is detected, based on the image data from one or more of the cameras 130, within a critical zone (e.g., a predefined threshold of distance of the dumper 100), the controller 150 may transmit a signal to temporarily inhibit propulsion (e.g., stop the engine 117), restrict motion in a particular direction (e.g., restrict operation of the machine controls 108), and/or apply braking force to halt movement by transmitting a signal either directly to the brakes 166 (see, e.g., FIG. 9) or indirectly to a component (e.g., an actuator) that controls the brakes 166. In general, the controller 150 may be configured to slow down or reduce a vehicle speed based on the detection of an object within the predetermined threshold of the dumper 100. In some embodiments, the controller 150 may use a tiered approach where the dumper 100 is initially slowed down by the controller 150 supplying a control signal to the brakes 166 in response to the cameras 130 detecting an object within a first predefined threshold, and then the controller 150 stopping the dumper 100 by suppling another control signal to the brakes 166 and/or stopping the engine 117, in response the object moving to a second predefined threshold that is closer to the dumper 100. In some embodiments, the system can log a detection event and store related image data or metadata for further review or analysis.

In some embodiments, the camera system 129 and the controller 150 may combine data with the one or more subsystems 164 to perform the object detection operations described herein. For example, the controller 150 may use the image data provided by one or more of the cameras 130 to detect the presence of an object and then the one or more subsystems 164 (e.g., a radar sensors, a LIDAR sensor, an object detection sensor, etc.) may be used to determine a distance of the detected object relative to the dumper 100. The one or more subsystems 164 may then be used to determine if the object crosses the predetermined threshold (or the first/second predetermined thresholds) and trigger slowing down and/or stopping the dumper 100. Alternatively or additionally, the image data from the cameras 130 may be used to classify an object (e.g., obstacle, stationary person, moving person, stationary vehicle, moving vehicle, etc.) and then the controller 150 may determine if a slowing-down action is required based on the proximity of the detected object to the dumper 100 (e.g., as determined by the one or more subsystems 164) and the classification of the object.

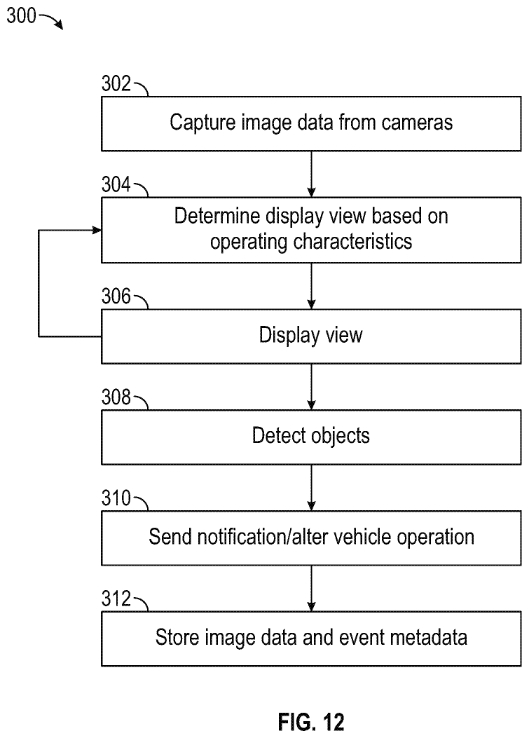

Turning to FIG. 12, a flow diagram of a vision-based monitoring process or method 300 for acquiring, processing, and displaying image data using the camera system 129 of the dumper 100 is shown according to an exemplary embodiment. The process 300 may be implemented using one or more components described herein, including the cameras 130a-130e, the display 113 (and/or the user device 126), and the controller 150. The steps of the process 300 may be performed sequentially, in parallel, or in an alternate order, and additional or fewer steps may be used depending on the system configuration.

At step 302, image data is captured from the cameras 130 disposed at predetermined positions on the dumper 100. The cameras 130 collectively cover a full 360-degree perimeter around the dumper 100, enabling comprehensive situational awareness. At step 304, the particular view to provide on the display 113 and/or the user device 126 is determined based on the operating characteristics of the dumper 100. As described herein, the operating characteristics of the dumper 100 include the direction that the seat 104 and/or the one or more machine controls 108 are facing, the position of the dump box 102, the drive condition (e.g., forward/neutral/reverse) of the one or more machine controls 108, and/or a speed of the dumper 100. The particular view displayed to the operator on the display 113 and/or the user device 126 is shown in FIG. 11 and described herein for the various combinations of operating conditions. In some conditions, as described herein, the image data captured from multiple cameras is fused into a unified output. In some embodiments, image fusion can be performed using geometric stitching techniques that align overlapping fields of view based on spatial reference points. In other embodiments, pixel-level blending, cylindrical projection, or spherical panorama generation can be used to eliminate seams or visual discontinuities. In certain configurations, the controller 150 may apply software-based correction algorithms (e.g., de-warping, frame synchronization, or temporal smoothing) to enhance clarity and ensure that the fused output is continuous and contextually coherent. For example, data from the first camera 130a, the second camera 130b, the third camera 130c, and the fourth camera 130d may be combined to render the top plan fused view shown in FIGS. 10 and 11. The image fusion views generated and displayed via the camera system 129 are not limited to the top plan view described and shown herein. For example, image data two or more of the cameras 130 may be fused and displayed on the display to show the operator a front-left fused view (the first camera 130a and the second camera 130b), a front-right fused view (the first camera 130a and the third camera 130c), a front-rear fused view (the first camera 130a and the fourth camera 130d or the fifth camera 130e).

At step 306, the particular view determined based on the operating characteristics at step 304 is displayed on the display 113 and/or the user device 126. The method 300 continually determines the operating characteristics at step 304 and automatically updates the display 113 and/or the user device 126 with the corresponding view during operation of the dumper 100. For example, a first view including image data from the one of the cameras 130 (e.g., the first camera 130a) may switch to a second view. The second view may include different or additional image data than the first view. For example, the second view may include image data from a different one of the cameras 130 (e.g., the fifth camera 130e) or a dual view including fused image data from a plurality of the cameras (e.g., the cameras 130a-130d) and image data from the camera in the first view (e.g., the first camera 130a). Alternatively or additionally, the first view may include one of the dual view configurations described herein (e.g., image data from the first camera 130a and the fused view), and the second view may include image data from one of the cameras (e.g., the first camera 130a), as described herein with respect to the speed changes of the dumper 100 and/or the position of the dump box 102.

At step 308, the image data is processed to detect the presence of persons, objects, vehicles, or environmental features within defined proximity regions around the dumper 100 (e.g., the field of view defined by each of the cameras 130a-130e) based on the image data from the cameras 130a-130e and/or the one or more subsystems 164 as described herein. In some embodiments, detection logic can be based on rule-based thresholding, edge detection, or motion segmentation. In more advanced implementations, the controller 150 may include onboard or cloud-connected processing hardware configured to run one or more machine learning models (e.g., convolutional neural networks or YOLO-style object detection algorithms) trained to recognize specific features, such as construction workers, equipment, barriers, cones, or uneven terrain. In some configurations, detection zones can be segmented based on camera position or priority, such that regions near the tires or dump box edges are analyzed with higher frequency or greater sensitivity.

At step 310, in response to detecting a person or object, a notification is generated and transmitted to the operator via the user interface 111. The notification may take the form of a visual indicator (e.g., a bounding box or flashing marker overlaid on the video feed), an audio tone or voice message emitted through the display speakers, or a haptic vibration if the display system is integrated into a handheld device. In some embodiments, the type of notification can vary depending on detection severity or region. For example, detection near the immediate path of travel may generate a louder or more persistent signal. In some configurations, the notification may also be transmitted to an external monitoring device or remote workstation.

At step 312, the controller 150 stores the image data and associated event metadata for post-operation analysis, recordkeeping, or audit purposes. For example, the stored data may include timestamped image frames, camera identifiers, detected object classification, and vehicle telemetry (e.g., speed, drive mode, dump box position). This information may be stored locally on the dumper 100 (e.g., in onboard memory) or transmitted over the network 128 to a remote server or cloud storage environment. In some implementations, the stored data may be used for operator review, training, or integration with site management systems. In some embodiments, the object detection, notification, and storage steps 308-312 occur simultaneously with the image capture, display determination, and viewing steps 302-306.

As utilized herein with respect to numerical ranges, the terms “approximately,” “about,” “substantially,” and similar terms generally mean+/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the dumper 100 and the camera system 129 as shown in the various exemplary embodiments is illustrative only. Additionally, any element disclosed in one embodiment may be incorporated or utilized with any other embodiment disclosed herein. For example, the exemplary embodiments of the camera system 129 shown at least in FIG. 9 may be incorporated into any version of the dumper 100 described herein with respect to FIGS. 1-5. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A dumper vehicle, comprising:
a chassis;
an operator console supported on the chassis and including a seat and one or more machine controls configured to selectively set a drive condition in a forward drive condition, a neutral drive condition, or a reverse drive condition;
a dump box pivotably coupled to the chassis so that a position of the dump box is selectively pivotable between a lowered position and a raised position;
a camera system including a plurality of cameras, each being positioned in a unique location on the dump box or the operator console and configured to capture image data within a respective region;
a user interface including a display; and
a controller in communication with the one or more machine controls, the camera system, and the user interface, the controller being configured to:
receive the image data from the plurality of cameras;
determine operating characteristics of the operator console and the dump box, wherein the operating characteristics include the drive condition and the position of the dump box;
instruct, based on the operating characteristics, the user interface to display a first view with image data from at least one of the plurality of cameras; and
instruct, based on a change in the operating characteristics, the user interface to switch from the first view to a second view that includes different or additional image data than the first view.

2. The dumper vehicle of claim 1, wherein the image data of the first view is from a first camera of the plurality of cameras arranged on a first end of the chassis.

3. The dumper vehicle of claim 2, wherein the image data of the second view is from a second camera of the plurality of cameras arranged on a second end of the chassis, opposite to the first end.

4. The dumper vehicle of claim 2, wherein the second view is a dual view including the image data from the first view and a fused view including image data from a subset of the plurality of cameras.

5. The dumper vehicle of claim 4, wherein each of the first camera, a second camera, a third camera, and a fourth camera is coupled to a different side of the dump box.

6. The dumper vehicle of claim 5, wherein the operator console is enclosed by a cab, and further comprising a fifth camera coupled to an upper panel of the cab.

7. The dumper vehicle of claim 5, further comprising a roll-over bar extending over the seat and a fifth camera coupled to the roll-over bar.

8. The dumper vehicle of claim 1, further comprising a dump box sensor configured to measure the position of the dump box between the lowered position and the raised position.

9. The dumper vehicle of claim 1, wherein the seat and the one or more machine controls are rotatably supported within the operator console so that a facing direction of the seat and the one or more machine controls is selectively rotatable between a dump box direction and a counterweight direction, and wherein the operating characteristics include the facing direction of the seat and the one or more machine controls.

10. The dumper vehicle of claim 9, further comprising a console position sensor configured to measure the facing direction of the seat and the one or more machine controls.

11. The dumper vehicle of claim 10, wherein the controller is configured to display the first view in a mirrored orientation, when the console position sensor indicates that the facing direction is in the counterweight direction, relative to the first view when the console position sensor indicates that the facing direction is in the dump box direction.

12. The dumper vehicle of claim 1, further comprising a speed sensor configured to measure a speed of the dumper vehicle, wherein the operating characteristics include the speed of the dumper vehicle.

13. The dumper vehicle of claim 12, wherein the change in the operating characteristics is the speed of the dumper vehicle being greater than a speed threshold.

14. The dumper vehicle of claim 1, wherein the change in the operating characteristics is the drive condition switching from one of the forward drive condition, the neutral drive condition, or the reverse drive condition to a different one of the forward drive condition, the neutral drive condition, or the reverse drive condition.

15. The dumper vehicle of claim 1, wherein the first view is a dual view with image data from a first camera of the plurality of cameras in a first section of the display and a fused view with image data from a subset of the plurality of cameras in a second section of the display.

16. The dumper vehicle of claim 15, wherein the second view is a single view with the image data from the first camera shown expanded over the first section and the second section of the display.

17. The dumper vehicle of claim 1, wherein the controller is configured to detect, based on the image data or data from an object detection sensor, an object within a predetermined threshold, and adjust an operating parameter of the dumper vehicle based on detecting the object within the predetermined threshold.

18. A dumper vehicle, comprising:
a chassis;
an operator console supported on the chassis and including a seat, wherein the seat is rotatably arranged within the operator console so that a facing direction of the seat is selectively rotatable between a dump box direction and a counterweight direction;
a console position sensor configured to measure the facing direction of the seat;
a dump box pivotably coupled to the chassis so that a position of the dump box is selectively pivotable between a lowered position and a raised position;
a dump box position sensor configured to measure the position of the dump box;
a speed sensor configured to measure a speed of the dumper vehicle;
a camera system including a plurality of cameras, each being positioned in a unique location on the dump box or the operator console and configured to capture image data within a respective region;
a user interface including a display; and
a controller in communication with the console position sensor, the speed sensor, the dump box position sensor, the camera system, and the user interface, the controller being configured to:
receive the image data from the plurality of cameras;
determine operating characteristics including the facing direction, the speed of the dumper vehicle, and the position of the dump box;
instruct, based on the operating characteristics, the user interface to display a first view; and
instruct, based on a change in the operating characteristics, the user interface to switch from the first view to a second view, wherein the first view is a dual view with image data from a first camera of the plurality of cameras in first section of the display and the second view is a single view with the image data from the first camera shown expanded over the first section and a second section of the display.

19. The dumper vehicle of claim 18, wherein the operator console includes one or more machine controls configured to selectively set a drive condition in a forward drive condition, a neutral drive condition, or a reverse drive condition, and wherein the operating characteristics include the drive condition.

20. A camera system for a dumper vehicle, the camera system comprising:
a console position sensor configured to measure a facing direction of a seat;
a dump box position sensor configured to measure a position of a dump box;
a speed sensor configured to measure a speed;
a plurality of cameras, each being positioned in a unique location and configured to capture image data within a respective region;
a user interface including a display; and
a controller in communication with the console position sensor, the speed sensor, the plurality of cameras, and the user interface, the controller being configured to:
receive the image data from the plurality of cameras;
determine operating characteristics including the facing direction, the speed of the dumper vehicle, and the position of the dump box;
instruct, based on the operating characteristics, the user interface to display a first view; and
instruct, based on a change in the operating characteristics, the user interface to switch from the first view to a second view, wherein the first view is a dual view with image data from a first camera of the plurality of cameras in first section of the display and the second view is a single view with the image data from the first camera shown expanded over the first section and a second section of the display.
